(19) United States
(12) Patent Application Publication
(10) Pub. No.: US 2018/0094332 A1
(43) Pub. Date: Apr. 5, 2018

(54) METHOD OF MANUFACTURING DIFFERENT VERSIONS OF A PILLAR REINFORCEMENT WITH A COMMON MOLD

(71) Applicant: Ford Global Technologies, LLC, Dearborn, MI (US)

(72) Inventors: Steven Frank, Dearborn, MI (US); Bhadresh V. Vyas, Canton, MI (US); Chienhom Lee, Farmington Hills, MI (US)

(73) Assignee: Ford Global Technologies, LLC, Dearborn, MI (US)

(21) Appl. No.: 15/286,070

(22) Filed: Oct. 5, 2016

(51) Int. Cl. C21D 9/00; B62D 25/04; B62D 27/02; B23K 26/21; B23K 26/32; C21D 1/18; B21D 47/01

(52) U.S. Cl. CPC C21D 9/0068; B62D 25/04; B62D 27/023; B23K 2201/006; B23K 26/32; C21D 1/18; B21D 47/01; B23K 26/21

(57) ABSTRACT

A method includes forming a short version of a pillar reinforcement and a long version of the pillar reinforcement from a short blank and a long blank, respectively. The long blank includes a first portion and a second portion joined to the first portion. The method includes inserting the short blank into a first section of a cavity of a mold and compressing the short blank in the mold to shape the short blank. The method also includes inserting the long blank into the mold with the first portion positioned in the first section of the mold and compressing the long blank in the mold to shape the long blank. The same mold is used to form both the short blank and the long blank into the short version of a pillar reinforcement and a long version of the pillar reinforcement.

### BACKGROUND

Different versions of the same vehicle may be designed to satisfy governmental requirements and/or consumer demands in various markets. As one example, impact tests for vehicles may vary between countries or regions. As another example, fuel economy requirements and/or consumer demand may vary between countries and regions. Accordingly, these various design factors may result in vehicles being designed differently based on the particular country or region in which the vehicle will be sold and/or operated.

### BRIEF DESCRIPTION OF THE DRAWINGS

FIG. 1 is a perspective view of a body of one version of a vehicle including a long version of a pillar reinforcement.

FIG. 2A is a perspective view of a long blank including a first portion joined to a second portion.

FIG. 2B is a perspective view of the long version of the pillar reinforcement of the body of FIG. 1.

FIG. 3 is a perspective view of a portion of the long version of the pillar reinforcement with a portion of a laser weld joining the first portion to the second portion shown in a magnified view.

FIG. 4 is a perspective view of a body of another version of the vehicle including a short version of a pillar reinforcement.

FIG. 5A is a perspective view of a short blank.

FIG. 5B is a perspective view of the short version of the pillar reinforcement of the body of FIG. 4.

FIG. 6 is a perspective view of a bottom end of the short version of the pillar reinforcement having a variable edge shown in a magnified view.

FIG. 7 is a schematic of a stamping line including a stack of long blanks, a stack of short blanks, a heating chamber, a stamping press, a trim press, and a quench booth.

FIG. 8 is a perspective view of a mold including a cavity having a first section and a second section adjacent the first section.

FIG. 9 is a perspective view of the long version of the pillar reinforcement being formed from the long blank in the mold.

FIG. 10 is a perspective view of the short version of the pillar reinforcement being formed from the short blank in the mold.

FIG. 11 is a flow diagram showing the steps of the method to manufacture the pillar reinforcement.

### DETAILED DESCRIPTION

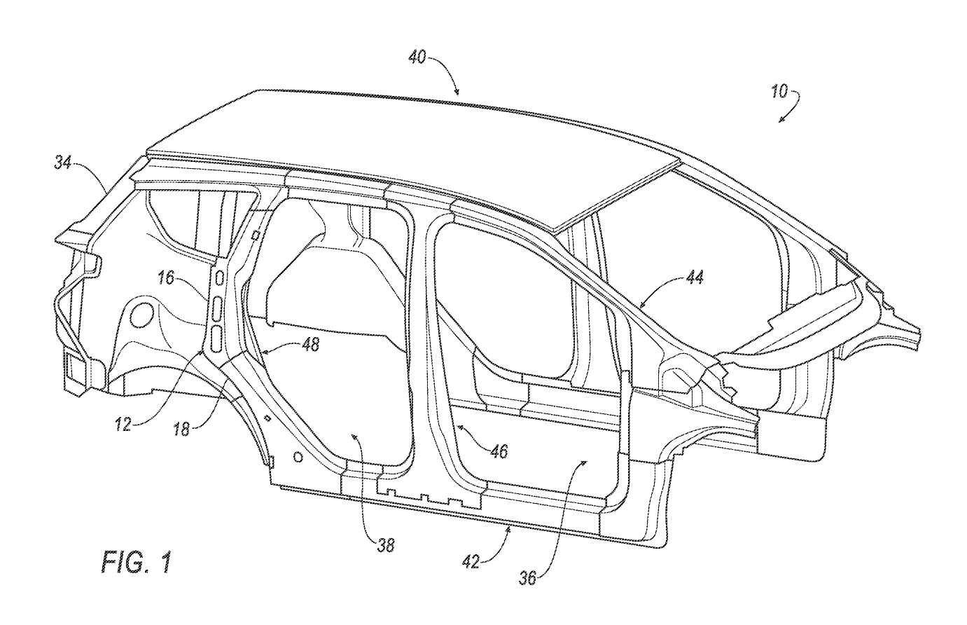

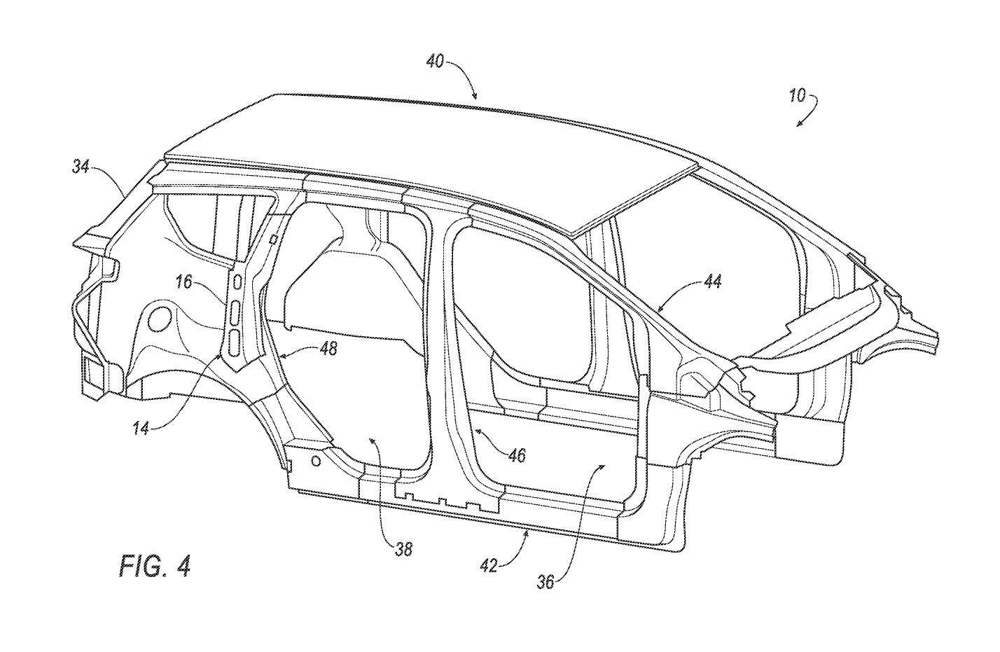

With reference to the Figures, wherein like numerals indicate like parts throughout the several views, a vehicle 10 includes a pillar reinforcement 12, 14. One model type of the vehicle 10 includes a long version of the pillar reinforcement 12, as shown in FIG. 1, and another model type of the vehicle 10 includes a short version of the pillar reinforcement 14 that is short relative to the long version, as shown in FIG. 4. In particular, the long version of the pillar reinforcement 12 shown in FIG. 1 includes both an upper leg 16 and a lower leg 18, and the short version of the pillar reinforcement 14 shown in FIG. 4 includes the upper leg 16 and not the lower leg 18. Common numerals are used to identify common features in the Figures, including features common to the two model types of the vehicle 10 shown in FIGS. 1 and 4.

A method 100 of manufacturing the pillar reinforcement 12, 14 includes providing a short blank 20 and a long blank 22. The long blank 22 includes a first portion 24 and a second portion 26 joined to the first portion 24. The method 100 includes inserting the short blank 20 into a first section 28 of a cavity 30 of a mold 32, compressing the short blank 20 in the mold 32 to shape the short blank 20, and removing the short blank 20 from the first section 28 after compressing. The method 100 also includes inserting the long blank 22 into the mold 32 with the first portion 24 positioned in the first section 28 of the mold 32, compressing the long blank 22 in the mold 32 to shape the long blank 22, and removing the long blank 22 from the mold 32 after compressing.

The mold 32 may be used to manufacture both the long version of the pillar reinforcement 12 and the short version of the pillar reinforcement 14. In other words, the same mold 32 may be used to manufacture the two different versions of the pillar reinforcement 12, 14. The ability to use the same mold 32 to manufacture two versions of the pillar reinforcement 12, 14 may reduce the cost of manufacturing and reduce the need for a unique tool to manufacture each version. Each version may be used to satisfy vehicle requirements unique to specific markets. For example, the long version of the pillar reinforcement 12 shown in FIGS. 1-3 may be used in some markets to satisfy impact testing, and the short version of the pillar reinforcement 14 shown in FIGS. 4-6 may be used in other markets to reduce weight and increase fuel economy.

The vehicle 10 may, for example, be any type of automobile, e.g., a car, truck, sport utility vehicle (SUV), etc. The vehicle 10 may have a uni-body construction, a body-on-frame construction, or any other construction.

As shown in FIGS. 1 and 4, the vehicle 10 may include a vehicle body 34 defining a front door opening 36 and a rear door opening 38. The vehicle body 34 may include a roof 40, a floor 42, and a plurality of pillars 44, 46, 48. The pillars 44, 46, 48 may be spaced from each other by the front door opening 36 and the rear door opening 38. In other words, the pillars 44, 46, 48 may be disposed on opposite sides of the door openings 36, 38. The pillars 44, 46, 48 include a B-pillar 46 separating the front door opening 36 and the rear door opening 38. The pillars also include an A-pillar 44 and a C-pillar 48 spaced from the B-pillar on opposite sides of the front door opening 36 and the rear door opening 38, respectively. The pillars may include additional pillars, e.g., a D-pillar (not shown) in the case of an extended SUV.

With continued reference to FIGS. 1 and 4, the pillar reinforcement 12, 14 may be connected to each of the pillars 44, 46, 48. Specifically, the pillar reinforcement 12, 14 may be connected to the C-pillar 48 to reinforce the C-pillar 48. For example, the long version of the pillar reinforcement 12, 14 may be connected to the C-pillar 48 from the roof 40 of the vehicle 10 to the floor 42, as shown in FIG. 1. In this instance, the long version of the pillar reinforcement 12, in conjunction with the roof 40 and the floor 42, may reduce the likelihood of intrusion during a side impact of the vehicle 10. In other words, the roof 40 to the floor 42 reinforce the long version of the pillar reinforcement 12. The short version of the pillar reinforcement 14 may be connected to the C-pillar 48 from the roof 40 to a position spaced from the floor 42, as shown in FIG. 4. The pillar reinforcement 12, 14 may be connected to the roof 40 and/or the C-pillar 48 (and/or the floor 42 in the instance of the long version of the pillar reinforcement 12) by welding, fastening, and/or any other connection type.

As set forth further below, the pillar reinforcement 12, 14 may be formed of metal, e.g., steel, aluminum, etc. As one example, the upper leg 16 of the long version of the pillar reinforcement 12 may be formed of high-strength steel, e.g., boron steel, and the lower leg 18 of the long version of the pillar reinforcement 12 may be formed of carbon steel. High-strength steel is a type of steel alloy that has greater strength than carbon steel. As other examples, the upper leg 16 and the lower leg 18 of the long version of the pillar reinforcement 12 may be formed of any combination steel, aluminum, or any other material. The material of the upper leg 16 of the long version of the pillar reinforcement 12, e.g., boron steel, may have a strength of 950-1250 MPa, e.g., 1100 MPa. The material of the lower leg 16 of the long version of the pillar reinforcement 12, e.g., carbon steel, may have a strength of 400-600 MPa, e.g., 500 MPa.

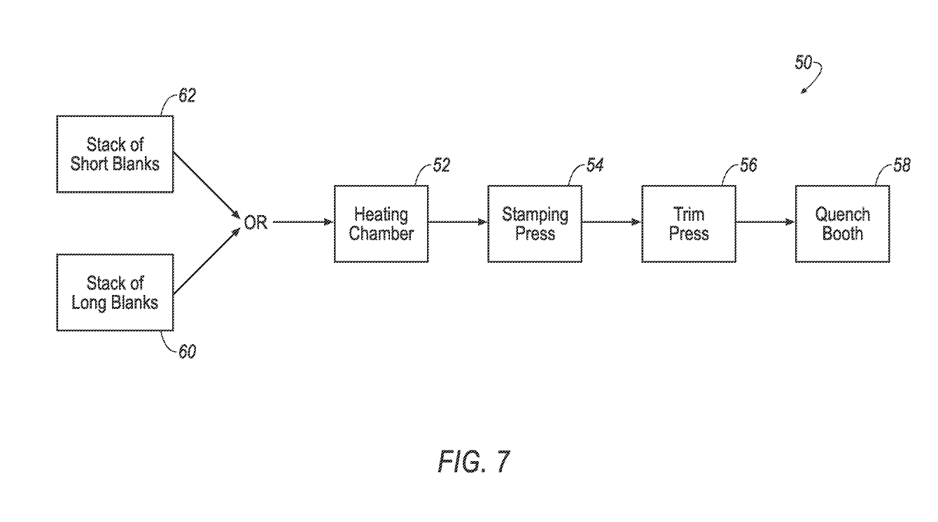

The long version of the pillar reinforcement 12 and the short version of the pillar reinforcement 14 are both formed on a stamping line 50, as shown in FIG. 7. In other words, both versions of the pillar reinforcement 12, 14 are formed on the same stamping line 50. As set forth further below, the stamping line 50 may include a heating chamber 52, a stamping press 54, a trim press 56, and a quench booth 58. In addition to these elements, the stamping line 50 may include any number of presses, booths, stations, etc., for forming the pillar reinforcement 12, 14. The blank, i.e., the long blank 22 or the short blank 20, may be moved between the presses, booths, stations, etc., of the stamping line 50.

With reference to FIG. 7, a stack of long blanks 60 and/or a stack of short blanks 62 may be positioned at the stamping line 50. One of the short blanks 20 may be passed through the stamping line 50 to form the short version of the pillar reinforcement 14. One of the long blanks 22 may be passed through the stamping line 50 to form the long version of the pillar reinforcement 12.

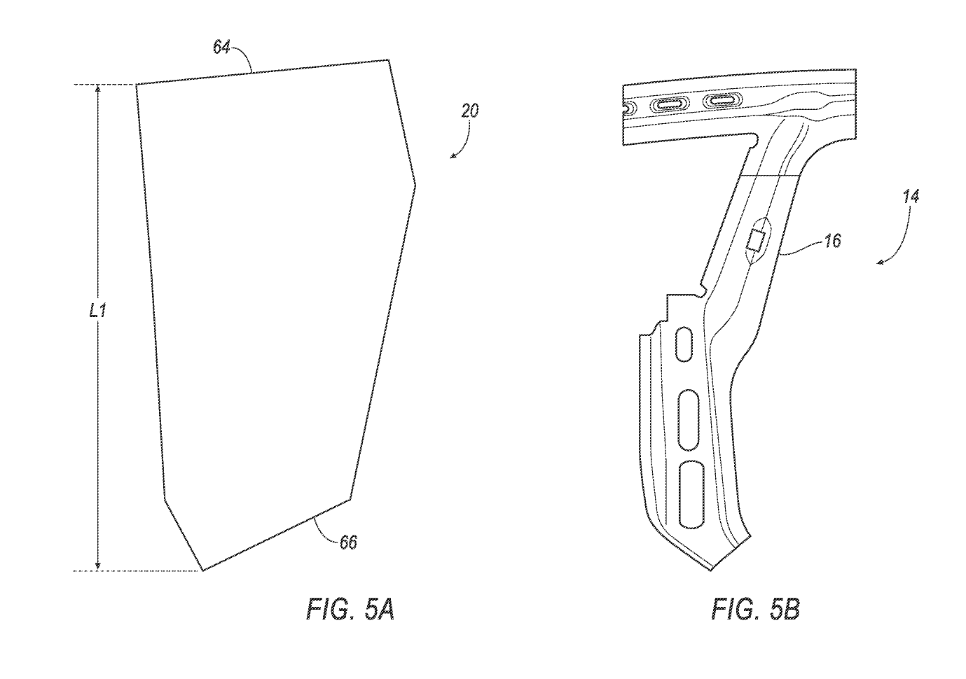

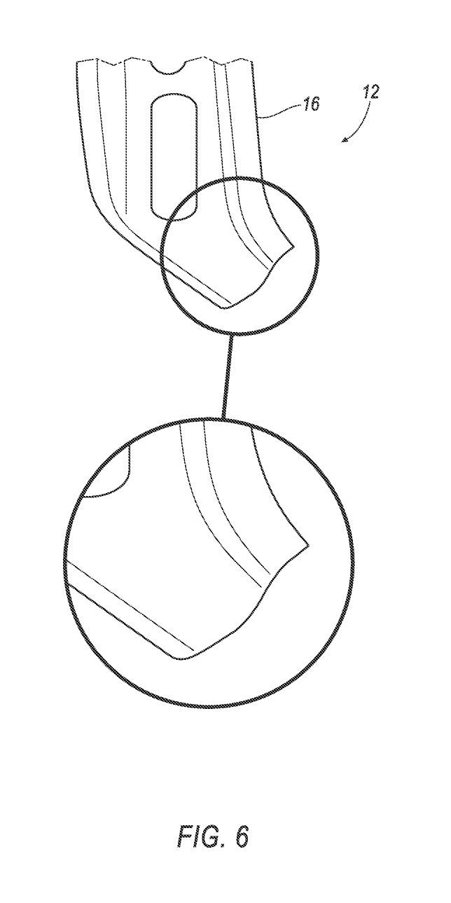

As shown in FIG. 5A, the short blank 20 includes a top end 64 and a bottom end 66 spaced longitudinally from the top end 64. The short blank 20 may be elongated along a length L1 from the top end 64 of the short blank 20 to the bottom end 66 of the short blank 20. The short blank 20 may have any suitable length. The short blank 20 may be formed into the short version of the pillar reinforcement 14, as shown in FIG. 5B. After being formed by the stamping press 54, the bottom end 66 of the short version of the pillar reinforcement 14 may have a nonlinear shape, as shown in FIG. 6.

The short blank 20 may be formed of metal. For example, the short blank 20 may be formed of high-strength steel, e.g., boron steel. Alternatively, as examples, the short blank 20 may be formed of any type of steel, aluminum, etc.

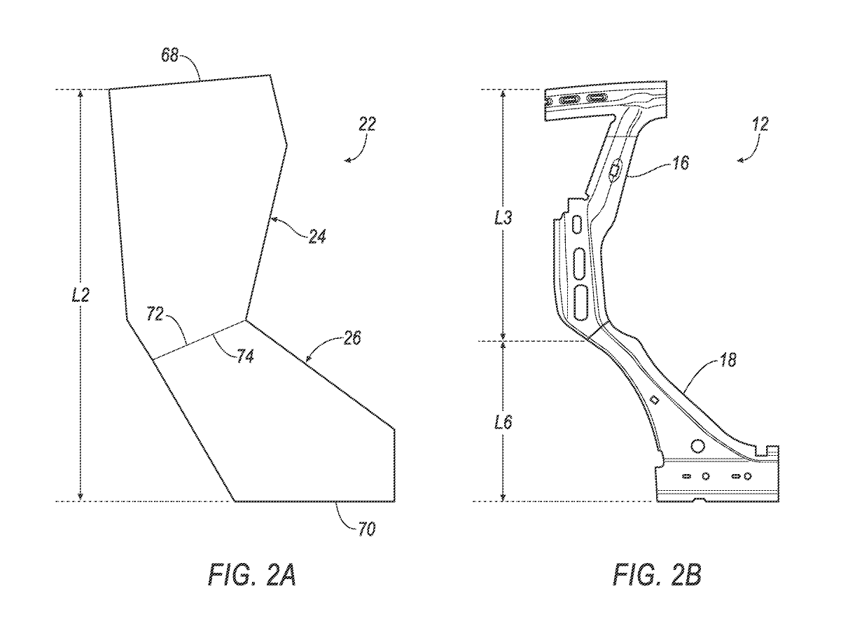

As shown in FIG. 2A, the long blank 22 may include a top end 68 and a bottom end 70 spaced longitudinally from the top end 68. The long blank 22 may be formed into the long version of the pillar reinforcement 12, as shown in FIG. 2B. The long blank 22 may be elongated along a length L2 from the top end 68 of the long blank 22 to the bottom end 70 of the long blank 22. The length L2 of the long blank 22 is greater, i.e., longer, than the length L1 of the short blank 20.

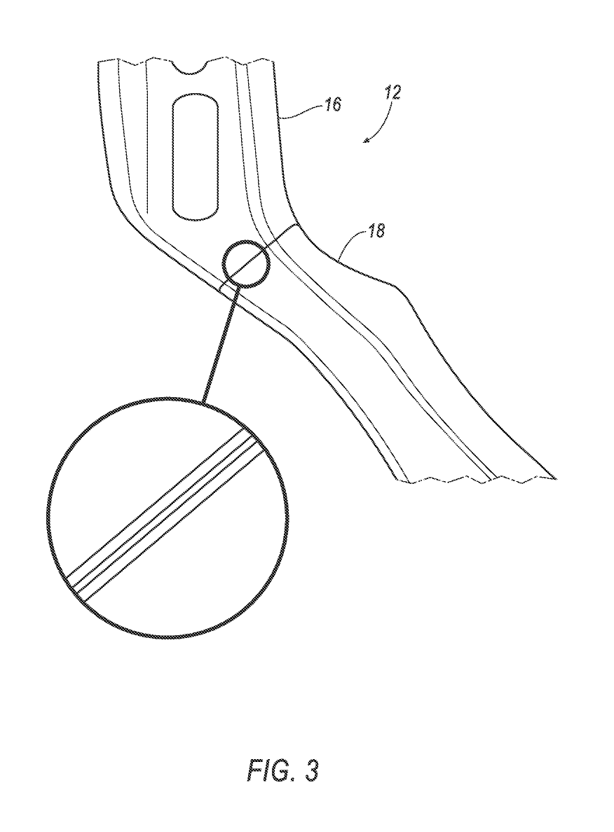

As shown in FIG. 3, the first portion 24 of the long blank 22 is joined to the second portion 26. The top end 68 of the long blank 22 is on the first portion 24 of the long blank 22 and the bottom end 70 of the long blank 22 is on the second portion 26 of the long blank 22. The first portion 24 of the long blank 22 is formed into the upper leg 16 of the pillar reinforcement 12, 14, and the second portion 26 of the long blank 22 is formed into the lower leg 18 of the pillar reinforcement 12.

As shown in FIG. 2A, the first portion 24 of the long blank 22 may include a bottom end 72 longitudinally spaced from the top end 68. The bottom end 72 of the first portion 24 abuts the second portion 26 of the long blank 22. Specifically, the second portion 26 of the long blank 22 may include a top end 74 longitudinally spaced from the bottom end 70. The top end 74 of the second portion 26 abuts the bottom end 72 of the first portion 24.

The top end 74 of the second portion 26, is joined to the bottom end 72 of the first portion 24, by any suitable joining technique. For example, the second portion 26 may be joined to the first portion 24 by laser welding. As other examples, the second portion 26 may be joined to the first portion 24 by spot welding, arc welding, brazing, etc.

The first portion 24 of the long blank 22 and the second portion 26 of the long blank 22 may be formed of a same or different type of material. As one example, the first portion 24 of the long blank 22 may be formed of a type of material having a first strength, and the second portion 26 of the long blank 22 may be formed of a type of material having a second strength less than the first strength. In other words, the second portion 26 of the long blank 22 may be weaker than the first portion 24 of the long blank 22. For example, the first portion 24 of the long blank 22 may have a strength of 950-1250 MPa, e.g., 1100 MPa, and the second portion 26 of the long blank 22 may have a strength of 400-600 MPa, e.g., 500 MPa.

The first portion 24 of the long blank 22 and the short blank 20 may have the same dimensions. In other words, the first portion 24 of the long blank 22 and the short blank 20 may have the same size and shape. For example, the top end 68 of the first portion 24 may be the same as the top end 64 of the short blank 20. As another example, the bottom end 72 of the first portion 24 may be the same as the bottom end 66 of the short blank 20. As yet another example, a length L3 of the first portion 24 may be the same as the length L1 of the short blank 20. When the first portion 24 of the long blank 22 and the short blank 20 are passed through the stamping press 54, respectively, the first portion 24 and the short blank 20 are each formed into the upper leg 16 of the pillar reinforcement 12, 14. In other words, the first portion 24 and the short blank 20, when passed through the stamping press 54, are formed in to identically sized and shaped parts.

The stamping line 50 may use any suitable metalworking process for forming one of the short blank 20 and the long blank 22 into the pillar reinforcement 12, 14. For example, various stages of the stamping line 50 may draw, flange, stretch, punch, trim, cut, or perform any other suitable metalworking process to form the short blank 20 and the long blank 22, respectively, into pillar reinforcement 12, 14.

With reference to FIG. 7, the heating chamber 52 heats the short blank 20 and the long blank 22. Specifically, the heating chamber 52 may be a blast furnace. The heating chamber 52 may heat the short blank 20 and the long blank 22 to any suitable temperature. For example, the short blank 20 and the long blank 22 may be heated to a temperature such that the mechanical properties of the metal, e.g., boron steel, are altered to allow the blanks to be shaped into the pillar reinforcement 12, 14.

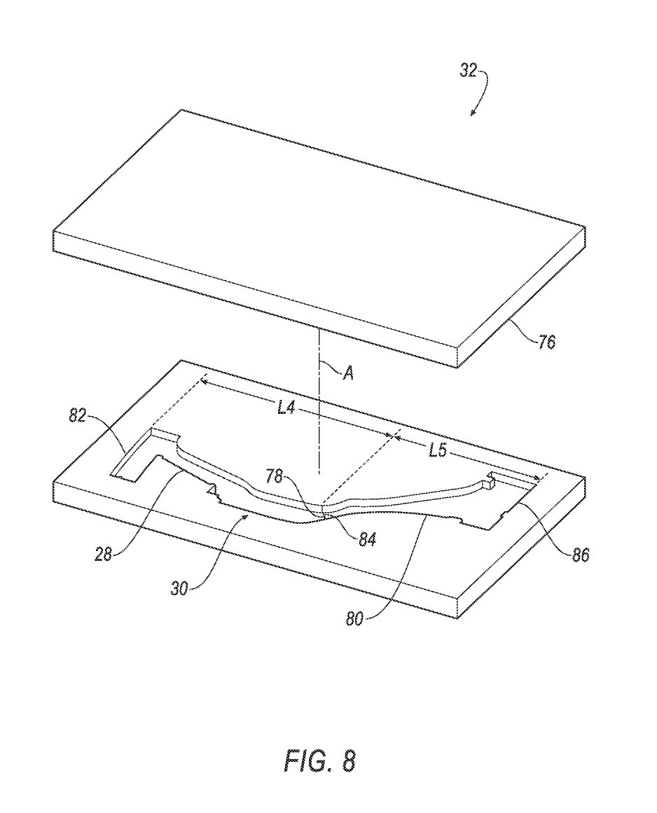

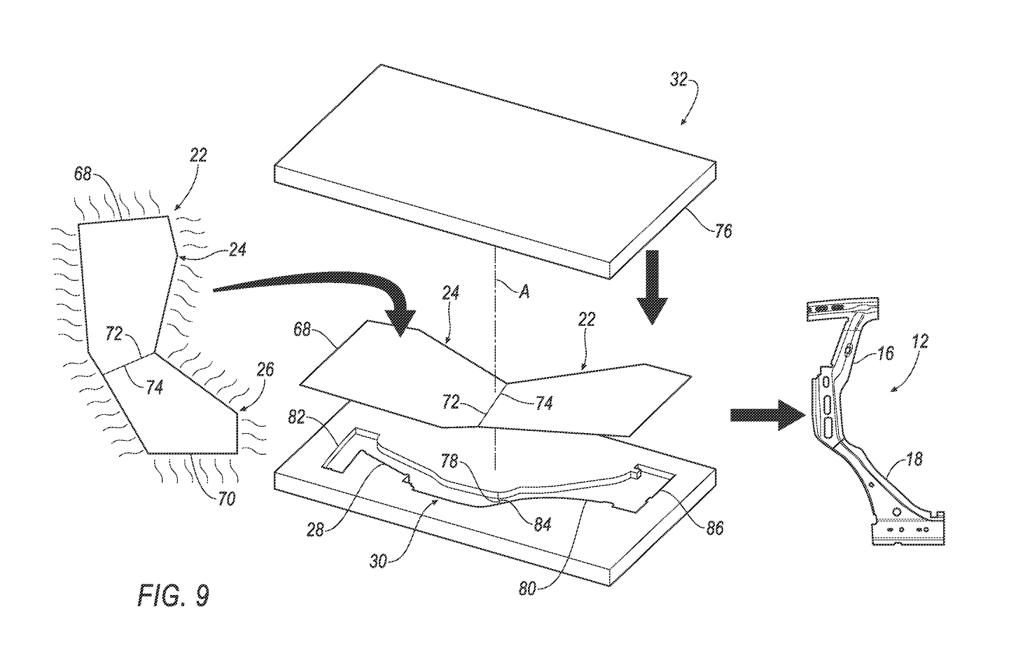

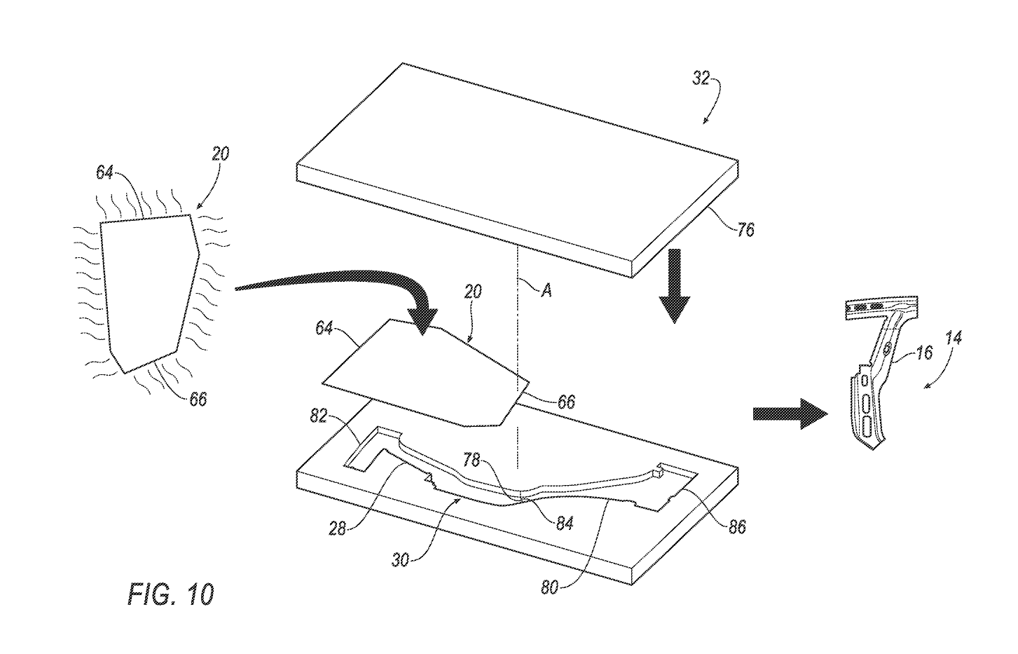

With continued reference to FIG. 7, the stamping press 54 forms one of the short blank 20 and the long blank 22 into the pillar reinforcement 12, 14. As shown in FIG. 8, the stamping press 54 may include the mold 32 for forming the short blank 20 and the long blank 22 into the pillar reinforcement 12, 14. In other words, the mold 32 may be used to form each of the short blank 20 into the short version of the pillar reinforcement 14 and to form the long blank 22 into the long version of the pillar reinforcement 12, as shown in FIGS. 9 and 10.

The mold 32 may include a die 76 and the cavity 30 selectively engageable with the die 76 along an axis A. The die 76 and the cavity 30 are moveable toward and away from each other to compress against the blank, i.e., the short blank 20 or the long blank 22, therebetween.

The cavity 30 of the mold 32 includes a second section 80 adjacent the first section 28 of the cavity 30. The first section 28 of the mold 32 includes a first end 78 abutting the second section 80, and the first section 28 includes a second end 82 spaced from the first end 78. The first section 28 of the cavity 30 may be elongated along a length L4 in a direction from the first end 78 to the second end 82 of the first section 28. The length L4 of the first section 28 of the cavity 30 is the same as the length L1 of the short blank 20 and/or length L3 of the first portion 24 of the long blank 22. The first section 28 has generally the same shape as the upper leg 16 of the pillar reinforcement 12, 14.

With continued reference to FIG. 7, the second section 80 of the cavity 30 includes a first end 84 abutting the first end 78 of the first section 28, and the second section 80 includes a second end 86 spaced from the first end 84. The second section 80 of the cavity 30 may be elongated along a length L5 in a direction from the first end 84 to the second end 86 of the second section 80. The second portion 26 of the long blank 22 has a length L6, and the length L5 of the second section 80 is the same as the length L6 of the second portion 26 of the long blank 22. The second section 80 of the cavity 30 has generally the same shape as the lower leg 18 of the pillar reinforcement 12.

With continued reference to FIG. 7, the trim press 56 removes excess material from the short blank 20 and the long blank 22. The trim press 56 may trim the blank, i.e., the short blank 20 or the long blank 22, before and/or after the blank is formed in the stamping press 54.

With continued reference to FIG. 7, the quench booth 58 cools the short blank 20 and the long blank 22. The quench booth 58 may soak the short blank 20 and the long blank 22 in a cooling fluid to reduce the temperature of the short blank 20 and the long blank 22. The cooling fluid may be any suitable fluid, e.g., water, oil, etc.

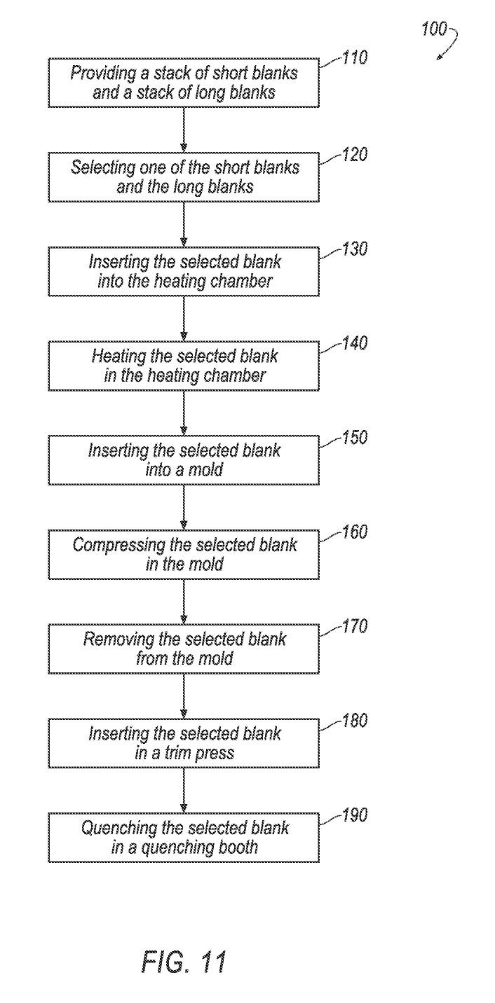

The method for manufacturing the pillar reinforcement 12, 14 is shown in FIG. 11. The method 100 may be used to manufacture both the long version of the pillar reinforcement 12 and the short version of the pillar reinforcement 14. For example, steps of the method 100 may be performed on the long blank 22 and performed separately on the short blank 20 to manufacture the long version of the pillar reinforcement 12 and the short version of the pillar reinforcement 14, respectively. The method 100 may be performed to consecutively manufacture a plurality of long versions of the pillar reinforcement 12 and to consecutively manufacture a plurality of short versions of the pillar reinforcement 14 before or after the manufacture of the long versions 12. As another example, the method 100 may be performed to manufacture any number of long versions and short versions of the pillar reinforcement 12, 14 in any order.

As shown block 110 in FIG. 11, the method 100 includes providing the stack of short blanks 62 and the stack of long blanks 60. The stack of short blanks 62 and the stack of long blanks 60 may be arranged in a manner such that the short blank 20 may be removable from the stack of short blanks 62, and the long blank 22 may be removable from the stack of long blanks 60. As another example the method 100 may include providing a single stack of short blanks 62 and long blanks 60 interspersed with each other.

As shown in block 120, the method 100 includes selecting one of the short blank 20 and the long blank 22 (hereinafter referred to as the “selected blank 20, 22”). As set forth above, the method 100 is repeated for a plurality of short blanks 20 and long blanks 22, i.e., the method 100 is repeated for a plurality of selected blanks 20, 22. The short blank 20 is selected to form the short version of the pillar reinforcement 14, as shown in FIG. 10, and the long blank 22 is selected to form the long version of the pillar reinforcement 12, as shown in FIG. 9. The short blank 20 and the long blank 22 may be selected and transferred between each of the presses, booths, stations, etc., of the stamping line 50 by robots or any way.

With reference to block 130, after selecting one of the short blank 20 and the long blank 22, the method 100 includes inserting the selected blank 20, 22 into the heating chamber 52 and, as shown in block 140, heating the selected blank 20, 22 in the heating chamber 52.

After being heated to a desired temperature in the heating chamber 52, as shown in block 150, the method 100 includes inserting the selected blank 20, 22 into the mold 32 of the stamping press 54. Specifically, when the selected blank 20, 22 is the short blank 20, the short blank 20 may be inserted into the mold 32, as shown in FIG. 10. Specifically, the short blank 20 may be inserted into the first section 28 of the cavity 30 of the mold 32. The short blank 20 may be positioned to be spaced from the second section 80 of the cavity 30 when inserted into the first section 28 of the cavity 30. In other words, the short blank 20 may be sized to be spaced from the second section 80 when inserted into the first section 28 of the cavity 30. When inserted in the first section 28 of the cavity 30, the bottom end 66 of the short blank 20 may be adjacent to and spaced from the second section 80 of the cavity 30. When the selected blank 20, 22 is the long blank 22, the long blank 22 may be inserted into the mold 32, as shown in FIG. 9. Specifically, the first portion 24 of the long blank 22 may be inserted into the first section 28 of the cavity 30. The long blank 22 may be positioned to extend across both the first section 28 and the second section 80 of the cavity 30. In other words, the long blank 22 may be sized to extend across both the first section 28 and the second section 80 of the cavity 30 when the first portion 24 is inserted into the first section 28.

The selected blank 20, 22 is removed from the mold 32 before another selected blank 20, 22 is inserted into the mold 32. In other words, the selected blank 20, 22 is inserted into an empty mold 32, i.e., when the mold 32 does not house a blank 20, 22, and only one blank 20, 22 is inserted into the mold 32 at a time.

As shown in block 160, the method 100 includes compressing the selected blank 20, 22 after inserting the selected blank 20, 22 into the mold 32. The cavity 30 and/or the die 76 are moved toward each other to apply a compressive force on the selected blank 20, 22. The force may be any suitable force necessary to shape the selected blank 20, 22. After the selected blank 20, 22 is molded, the method 100 includes removing the selected blank 20, 22 from the mold 32, as shown in block 170.

As shown in block 180, the method 100 includes inserting the selected blank 20, 22 into the trim press 56. The trim press 56 cuts the selected blank 20, 22. After selected blank 20, 22 has been trimmed, the method 100 includes removing the selected blank 20, 22 from the trim press 56.

As shown in block 190, the method 100 includes quenching the selected blank 20, 22 in the quench booth 58 to reduce the temperature of the selected blank 20, 22. After quenching, the method 100 is completed and the completed pillar reinforcement 12, 14 may be placed on racks for transportation.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A method comprising:
providing a short blank and a long blank, the long blank including a first portion and a second portion joined to the first portion;
inserting the short blank into a first section of a cavity of a mold, compressing the short blank in the mold to shape the short blank, and removing the short blank from the first section after compressing;
inserting the long blank into the mold with the first portion positioned in the first section of the mold, compressing the long blank in the mold to shape the long blank, and removing the long blank from the mold after compressing.

2. The method according to claim 1, wherein the first portion of the long blank has the same dimension as the short blank.

3. The method according to claim 1, wherein the cavity of the mold includes a second section adjacent the first section, wherein the short blank is positioned to be spaced from the second section of the cavity when inserted into the first section of the cavity, and wherein the long blank is positioned to extend across both the first section and the second section of the cavity when inserted into the first section of the cavity.

4. The method according to claim 1, wherein the cavity of the mold includes a second section adjacent the first section, wherein the short blank is sized to be spaced from the second section when inserted into the first section of the cavity, and wherein the long blank is sized to extend across both the first section and the second section when inserted into the first section.

5. The method according to claim 1, wherein the second portion is joined to the first portion by laser welding.

6. The method according to claim 1, wherein the first portion of the long blank is a type of material having a first strength and the second portion of the long blank is a type of material having a second strength less than the first strength.

7. The method according to claim 6, wherein the short blank and the first portion of the long blank are the same type of material.

8. The method according to claim 1, wherein the short blank and the first portion of the long blank are the same type of material.

9. The method according to claim 1, wherein the first portion of the long blank is high-strength steel and wherein the short blank is high strength steel.

10. The method according to claim 1, wherein the short blank and the long blank are metal.

11. The method according to claim 1, wherein the long blank is elongated along a length and wherein the short blank is elongated along a length, the length of the long blank being greater than the length of the short blank.

12. The method according to claim 1, wherein the cavity of the mold includes a second section adjacent the first section, wherein the short blank includes a bottom end in the first section of the mold when the short blank is inserted into the mold, the bottom end being adjacent to and spaced from the second section of the mold when the short blank is inserted into the mold.

13. The method according to claim 1, wherein the first portion of the long blank is an upper leg of a pillar reinforcement, and the second portion of the long blank is a lower leg of the pillar reinforcement, and wherein the pillar reinforcement is a pillar reinforcement.

14. The method according to claim 1, wherein the short blank is an upper leg of a pillar reinforcement, and wherein the pillar reinforcement is a pillar reinforcement.

15. The method according to claim 1, further comprising heating the short blank before inserting the short blank into the cavity and heating the long blank before inserting the long blank into the cavity.

16. The method according to claim 1, wherein inserting the long blank into the mold and removing the long blank from the mold occurs after removing the short blank from the mold or before inserting the short blank into the mold.
